(19) United States
(12) Patent Application Publication
(10) Pub. No.: US 2009/0119959 A1
(43) Pub. Date: May 14, 2009

(54) COLORED SNAP BACKING SYSTEM

(76) Inventor: Kari L. Brown, Rocklin, CA (US)

Correspondence Address: RAY K. SHAHANI, ESQ., ATTORNEY AT LAW, TWIN OAKS OFFICE PLAZA, 477 NORTH NINTH AVENUE, SUITE 112, SAN MATEO, CA, 94402-1858, US

(21) Appl. No.: 11/938,119

(22) Filed: Nov. 9, 2007

(51) Int. Cl. G09F 3/00; A41D 11/00; G09B 19/00

(52) U.S. Cl. 40/315; 2/243.1; 434/395

(57) ABSTRACT

A colored snap backing fastening system for effective closure of openings in any baby garment, the colored snap fastening system consisting of colored snap fasteners installed in series along the opposite sides of any opening on a baby garment, each colored snap backing fastener further consisting of a matching pair of stud and socket portions, a pair of backing portions adjacent to the fabric and between the fabric and each of the stud portion and socket portions whereas each pair of the backing portions has an unique visual indicator associated therewith.

### FIELD OF THE INVENTION

This invention relates to a colored snap backing system, and more specifically to a color coded snap backing fastening system, with multi-color backings for use on children's garments, to simplify the fastening process.

### BACKGROUND OF THE INVENTION

Snap fasteners 90 or snaps are a type of clasp or fastener that closes with a click. Snaps 90 were made popular in the 1940's when the 4-part gripper style snaps, as shown in FIG. 1 (PRIOR ART), were available to home sewing consumers. In general, snaps 90 consist of two units, the closure unit 50 which include a socket 88 and a stud 92 and the attaching unit 40. In general, there are two types of snaps 90, post style and prong style. The post style snap has a shaft in its attaching unit 40 which includes a capped post 94 and a post 96. A post style snap requires a hole to penetrate the fabric it is applied on. On the other hand, the prong style snap has teeth on its attaching unit 40, namely a capped prong ring 84 and an open prong ring 86, that penetrate through the fabric it is applied on.

FIG. 1 (PRIOR ART) is a representative view showing two common assemblies of snap fastener 90 of the prior art. Two of the most common snap assemblies are post-style snap fastener 60 and prong-style snap fastener 70. Regardless of style, in general a snap fastener system 90 consists of two main units namely a closure unit 50 and an attaching unit 40. In one embodiment, closure unit 50 further consists of a male part called stud 92 and female part called socket 88 and together stud 92 and socket 88 form a temporary and tight closure when they are snapped together. In one embodiment, attaching unit 40 further consists of capped post 94 and post 96 in the post-style snap fastener 60 or a capped prong ring 84 and open prong ring 60 in the prong-style snap fastener 70. In one embodiment, the main function of capped post 94 and capped prong ring 84 is to secure socket 88 at the desirable position of application by piercing through fabric or adjoining material with the post or prongs and mechanically coupling with the socket 88. In one embodiment, post 96 or open prong ring 86 perform the same function on the stud 92. In one embodiment, with both stud 92 and socket 88 both secured on desirable location on clothing or any other article, the snap fastening system 90 provides a temporary but secure closure.

Snaps 90 are one of the most common fasteners on baby and toddler's clothing for both safety and convenience reasons. Unlike buttons which can be unattached easily and swallowed by babies, snaps are attached firmly by mechanical means. Additionally, it is much easier to open a series of snaps than to unbutton a series of buttons. Zippers, although easy to close and open, may cause injury to moving babies or during a rush situation.

In baby clothing, a plurality of snaps 90 are usually found in and around the crotch area or in-seams. Some clothing may take up to 20 snaps 90 to close an opening. Users often find it difficult to close a long series of snaps 90 and often mismatch studs 92 and sockets 88 especially when babies are moving, when starting a row of snaps 90, when coupling snaps 90 at different locations or positions along the row of snaps 90, etc.

### ADVANTAGES AND SUMMARY OF THE INVENTION

One advantage and object of the present invention is to provide an efficient and effective way to close baby's garment especially when babies are constantly moving while being dressed.

Another advantage and object of the present invention is to prevent users from snapping together unmatched studs and sockets.

Yet another advantage and object of the present invention is to enhance the design of baby garments by having colored snap fasteners.

Yet another advantage and object of the present invention is to provide an education opportunities for toddlers to learn how to dress themselves.

The present invention is a colored snap backing fastener for use in coupling two pieces of material together. The colored snap backing fastener consists of an operational pair of stud and socket portions, a pair of attaching units which provide an anchor point for securing the position of the stud and socket portions onto material and a pair of backing portions, which is adjacent to the material and between the material and each of the stud and socket portions, the pair of backing portions each having an identical visual indicator associated therewith.

The pair of backing portions of the colored snap backing fastener are attached to material by one of the group consisting of sewing, iron-on, adhesive or combinations thereof.

The pair of backing portions of the colored snap backing fastener are a piece of material dyed in a solid color.

Alternatively, the pair of backing portions of the colored snap backing fastener are a piece of material dyed in a colored pattern.

The visual indicator of the colored snap backing fastener is selected from the group consisting of unique solid color, unique colored pattern, unique shape, unique design and combinations thereof.

The pair of backing portions of the colored snap backing fastener are in a predetermined shape selected from following group of shapes: round, oval, square and rectangular.

The present invention is also a colored snap backing fastening system for effective closure of material and fabric items. The colored snap backing fastening system consists of a few of colored snap backing fasteners that are installed in series onto a piece of fabric along the opposite sides of any opening on a baby garment, each of the series of colored snap backing fasteners further consists of a matching pair of stud and socket portions with attaching units, a pair of backing portions that are adjacent to the fabric and between the fabric and each of the stud and socket portions, each pair of backing portions each having an identically unique visual indicator associated therewith, the visual indicator is color, colored pattern, shape and combinations thereof.

The present invention is also a method for closing an infant garment. The method comprising the steps of obtaining an infant garment that consists of a few of colored snap backing fasteners that are installed in series onto a piece of fabric along the opposite sides of any opening on a baby garment, each of the series of colored snap backing fasteners further consists of a matching pair of stud and socket portions with attaching units, a pair of backing portions that are adjacent to the fabric and between the fabric and each of the stud and socket portions, each pair of backing portions each having an identically unique visual indicator associated therewith, the visual indicator is color, colored pattern, shape and combinations thereof, Identifying the matching visual indicator on paring stud and socket portions and closing each colored snap fastener in matching color.

The present invention is also a method for educating toddlers to dress themselves. The method consists of the steps of obtaining a toddler's garment that consists of a few of colored snap backing fasteners that are installed in series onto a piece of fabric along the opposite sides of any opening on a baby garment, each of the series of colored snap backing fasteners further consists of a matching pair of stud and socket portions with attaching units, a pair of backing portions that are adjacent to the fabric and between the fabric and each of the stud and socket portions, each pair of backing portions each having an identically unique visual indicator associated therewith, the visual indicator is color, colored pattern, shape and combinations thereof, teaching and instructing toddlers to identify the matching visual indicator on paring stud and socket portions, asking toddlers to close each colored snap fastener in matching color and providing immediate feedbacks whether toddlers are selecting matching stud and socket portions correctly.

### BRIEF DESCRIPTION OF THE DRAWINGS

FIG. 1 (PRIOR ART) is a representative view showing two common assemblies of snap fastener 90 of the prior art.

FIG. 2A is a representative top view of an embodiment of the socket portion of the color coded snap backings system 100 of the present invention.

FIG. 2B is a representative top view of an embodiment of the stud portion of the colored snap backing system 100 of the present invention.

FIG. 3A is a representative side exploded view of an embodiment of the socket portion of the colored snap backing system 100 of the present invention.

FIG. 3B is a representative side exploded view of an embodiment of the stud portion of the colored snap backing system 100 of the present invention.

FIG. 4 shows a representative method of use of an embodiment of the stud portion of the colored snap backing system 100 of the present invention.

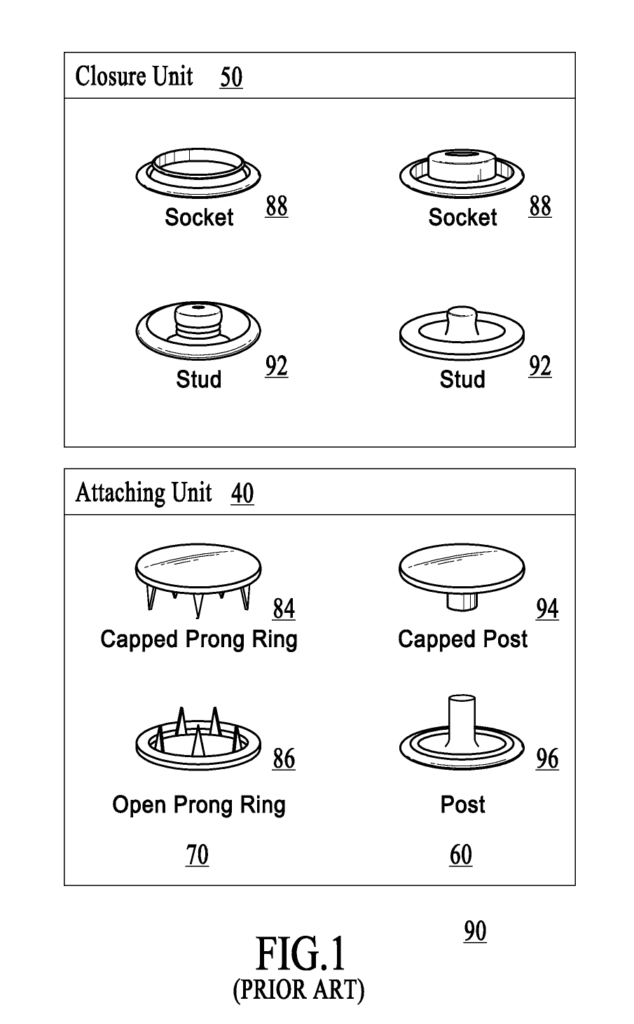

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

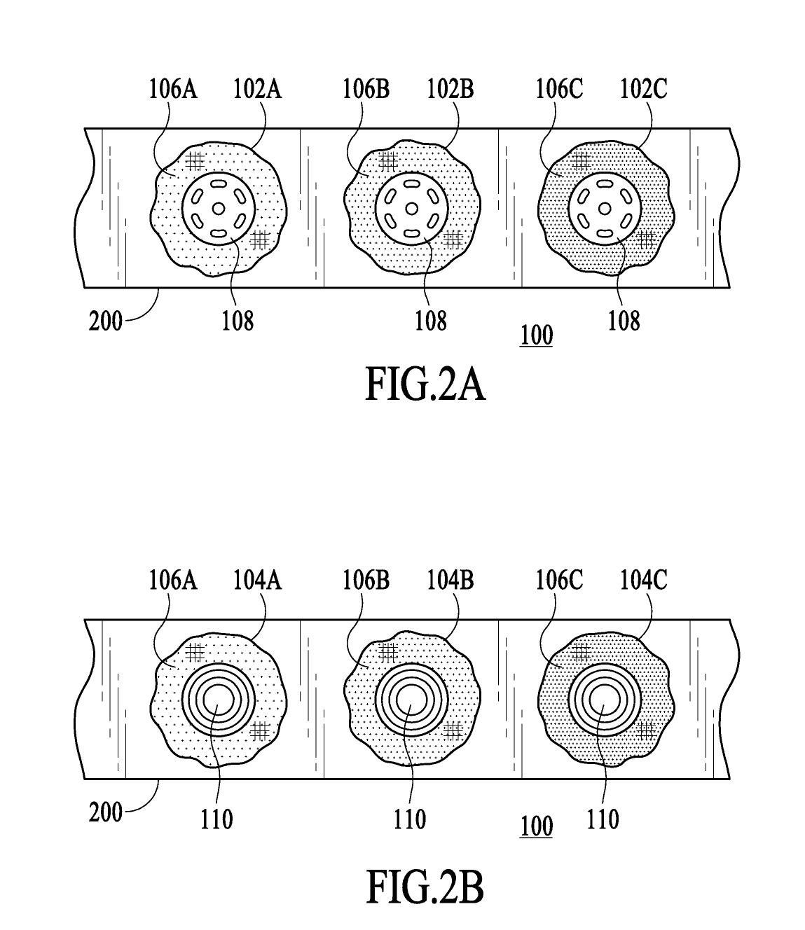

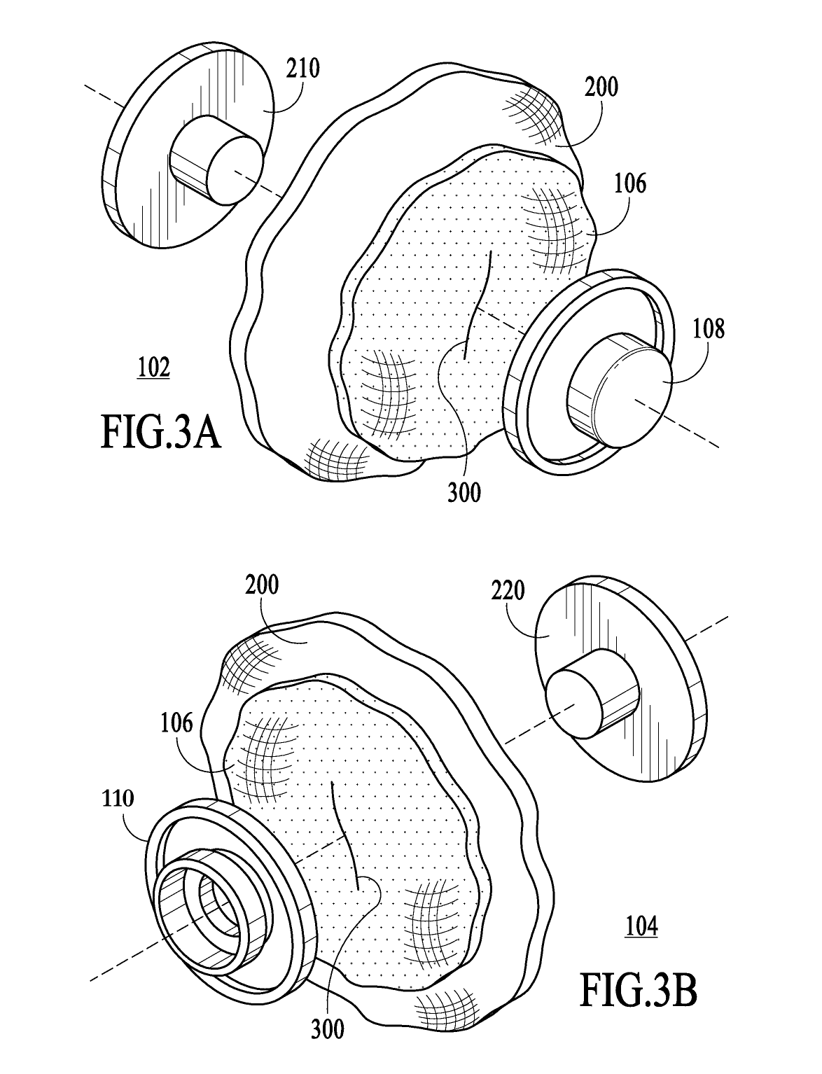

FIG. 2A is a representative top view of an embodiment of the stud assembly portion 102 of the colored snap backing system 100 of the present invention. As best shown in FIGS. 2A and 3A, stud assembly portion 102 consists essentially of stud 108, color backing 106 and a matching attaching unit 210. In one embodiment, each stud assembly portion 102 in the series of stud assembly portions 102A, 102B, 102C has a color backing 106A, 106B and 106C; each in a distinctively different color and/or pattern. Stud 108 must be placed on top of color backing 106A. As seen in FIG. 2A, color backing 106A is a piece of colored clothing patch in the shape of circle, oval, square or other shapes as long as it is larger than the top profile of stud 108 and easily visible. Color backing 106A is either sewn, stuck or by other methods to be secured permanently on fabric 200. Fabric 200 can be any type of cloth materials but preferably is a woven, non-fusible interfacing. As shown in FIG. 2A, a series of stud assembly portions 102A, 102B, 102C can be installed on fabric 200 to assemble the colored snap backing system 100. In one embodiment, color backing 106A, 106B, 106C should be in different and distinctive colors and/or patterns. Also, the color on specific color backing 106A, 106B, 106C should be exactly the same as their corresponding socket assembly portion 104A, 104B, 104C. The number of stud assembly portions 102 is not limited and should be corresponding to the length of enclosure as long as color backings 106 are in different colors and/or patterns. Alternatively, stud assembly portions 102 that feature repeated color backings 106 should be placed further enough to avoid confusion.

FIG. 2B is a representative top view of an embodiment of the socket assembly portion 104 of the colored snap backing system 100 of the present invention. As best shown in FIGS. 2B and 3B, socket assembly portion 104A consists essentially of socket 110, color backing 106 and a matching attaching unit 220. In one embodiment, each socket assembly portion 104 in the series of socket assembly portions 104A, 104B, 104C has a color backing 106A, 106B and 106C; each in a distinctively different color. Socket 110 must be placed on top of color backing 106A. As seen in FIG. 2B, color backing 106A is piece of colored clothing patch in the shape of circle, oval, square or other shapes as long as it is larger than the top profile of socket 110 and easily visible. Color backing 106A is either sewn, stuck or by other methods to be secured permanently on fabric 200. In one embodiment, fabric 200 can be any type of cloth materials but preferably is a woven, non-fusible interfacing. As shown in FIG. 2B, a series of socket assembly portions 104A, 104B, 104C can be installed on fabric 200 to assemble the colored snap backing system 100. In one embodiment, color backing 106A, 106B, 106C should be in different and distinctive colors and/or patterns. Also, the color on specific color backing 106A, 106B, 106C should be exactly the same as their corresponding stud assembly portion 102A, 102B, 102C. The number of socket assembly portions 104 is not limited and should be corresponding to the length of enclosure as long as color backings 106 are in different colors and/or patterns. Alternatively, socket assembly portions 104 that feature repeated color backings 106 should be placed further enough to avoid confusion.

As shown in FIG. 2B, corresponding stud 108 and socket 110 on corresponding pair of the stud assembly portion 102A and socket assembly portion 104A must have a tight fit. It is preferable to have same kind and size of studs 108 and sockets 110 in the colored snap backing system 100 of the present invention to provide a uniform look and enclosure.

FIG. 3A is a representative side exploded view of an embodiment of the stud assembly portion 102 of the colored snap backing system 100 of the present invention. As shown in FIG. 3A, color backing 106A is either sewn, stuck or by other methods to be secured permanently on fabric 200. In one embodiment, stud attaching unit 210 can be a post, a open prong ring or other style of stud attaching unit 210 and it pierces through both fabric 200 and color backing 106 at slit opening 300 and is secured mechanically to stud 108 thereby securing its position on color backing 106.

FIG. 3B is a representative side exploded view of an embodiment of the socket assembly portion 104 of the colored snap backing system 100 of the present invention. As shown in FIG. 3B, color backing 106A is either sewn, stuck or by other methods to be secured permanently on fabric 200. Socket attaching unit 220 can be a capped post, a capped prong ring or other style of socket attaching unit 220 and it pierces through both fabric 200 and color backing 106 at slit opening 300 and is secured mechanically to socket 110 thereby securing its position on color backing 106.

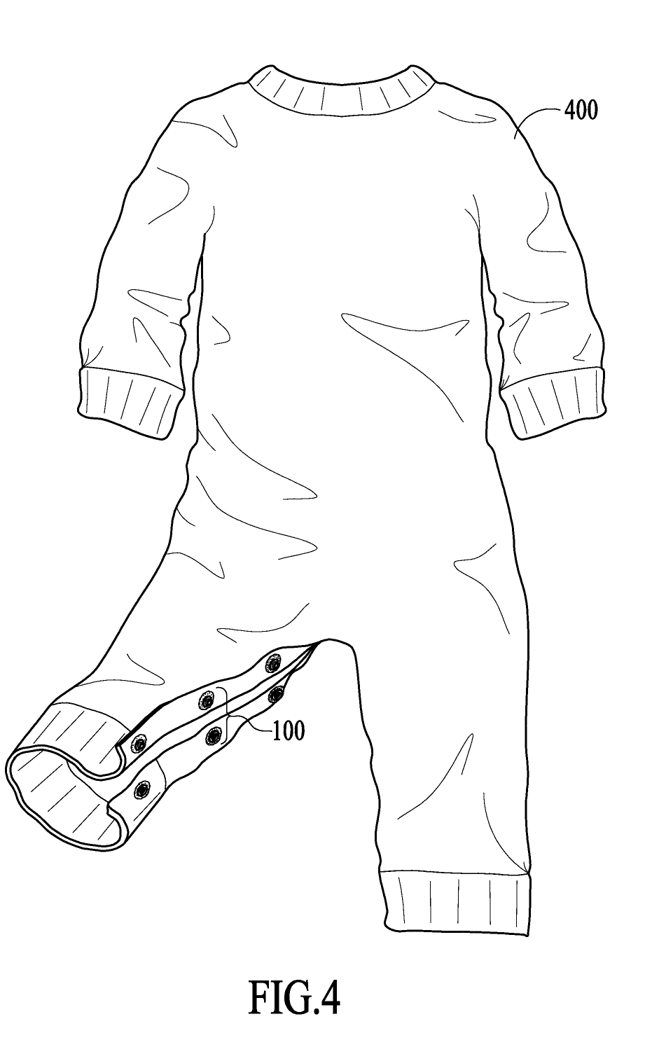

FIG. 4 shows a representative method of use of the colored snap backing system 100 of the present invention. As shown in FIG. 4, the colored snap backing system 100 of the present invention can be applied on any opening on baby clothing 400 such as in seam, shoulder. Depending on the length of enclosure, a plurality of socket assembly portions 104 and their matching stud assembly portions 102 are installed along opposite sides of the enclosure. Color backings 106A, 106B, 106C, etc. in different colors and/or patterns are installed in individual socket assembly portions 104 and their matching stud assembly portions 102 to make them visually distinctive from each other. Users can easily pick and snap close corresponding socket assembly portions 104 and their matching stud assembly portions 102 by their matching color and close the entire enclosure efficiently and effectively.

The efficient closing of baby garments are particularly important so that users are able to snap close the in-seam quickly and without fussing over selecting and closing the correct pair of stud and socket when the baby is constantly moving.

Moreover, the colored snap backing system 100 can also be an effective education tool to teach toddlers to dress themselves. The color backings 106 of the present invention 100 provide strong visual identifiers for toddlers to learn color matching. Toddlers can simply match the colors on matching studs and sockets and snap close them one by one.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1-7. (canceled)

8. A method for closing an infant garment, the method comprising the following steps:
Obtaining an infant garment comprising a plurality of colored snap backing fasteners installed in series onto fabric along the opposite sides of any opening on a baby garment, each of the series of colored snap backing fasteners further comprising a matching pair of stud and socket portions with attaching units, a pair of backing portions, adjacent the fabric and between the fabric and each of the stud and socket portions, each pair of backing portions each having an identically unique visual series of different color indicator associated therewith such that each pair of stud and sockets has a unique color associated therewith, thereby reducing the possibility that a user might mis-match any given stud or socket pair;
Identifying the matching visual indicator on paring stud and socket portions by matching the colors of a first pair of colored snap backing fasteners associated with a first mating pair of stud and socket portions, then by matching the colors of subsequent pairs of colored snap backing fasteners associated with subsequent mating pairs of stud and socket portions such that all stud and socket portions are mated correctly; and
Closing each colored snap fastener in matching color.

9. (canceled)
